(19) United States
(12) Patent Application Publication
(10) Pub. No.: US 2004/0222599 A1
(43) Pub. Date: Nov. 11, 2004

(54) Pipe joint gasket with closed end face

(76) Inventor: James W. Skinner, Fort Wayne, IN (US)

Correspondence Address: BAKER & DANIELS, 111 E. WAYNE STREET, SUITE 800, FORT WAYNE, IN, 46802

(21) Appl. No.: 10/719,101

(22) Filed: Nov. 21, 2003

Related U.S. Application Data
(63) Continuation-in-part of application No. 10/461,725, filed on Jun. 13, 2003.
(60) Provisional application No. 60/467,992, filed on May 5, 2003.

(51) Int. Cl. F16L 21/02

(52) U.S. Cl. 277/619

(57) ABSTRACT

A pipe joint gasket with a closed end face. An annular anchoring projection extends outwardly from the external surface of the gasket and is embedded within a structure with which the gasket is used. The gasket also includes a sealing projection for engaging a pipe to provide a compressive, fluid tight seal between the pipe and the gasket. In applications in which the gasket is used for a pipe joint, the closed end face of the gasket may be slit or removed to allow a pipe to pass through the gasket. Alternatively, in applications in which the gasket is not used for a pipe joint, the end face remains intact, and has a thickness sufficient to withstand internal pressures within the structure and external pressures from without the structure. In an alternate embodiment, the gasket is configured for use with at least two different sizes of pipe.

### CROSS REFERENCE TO RELATED APPLICATIONS

This application is a continuation-in-part of U.S. patent application Ser. No. 10/461,725, entitled PIPE JOINT GASKET WITH CLOSED END FACE, filed on Jun. 13, 2003, which claims the benefit under Title 35, U.S.C. § 119(e) of U.S. Provisional Patent Application Serial No. 60/467,992, entitled PIPE JOINT SEAL WITH CLOSED END FACE, filed on May 5, 2003.

### BACKGROUND OF THE INVENTION

1. Field of the Invention

The present invention relates to gaskets or seals for use in a pipe joint application, in which the gaskets seal a connection between an opening in a structure and a pipe extending through the opening.

2. Description of the Related Art

In general, pipe joint gaskets or seals are well known in the art for sealing a pipe joint connection between a pipe and a structure in which the pipe is mounted. In one particular application, a pipe joint is formed between a sewer pipe and a concrete manhole riser, for example, in which a sewer pipe is inserted through a gasket embedded within the concrete wall of the manhole riser. In other applications, pipe joints may be provided to connect pipes to septic tanks, for example, or may be provided in any other structures to which pipes are connected.

Pipe joint gaskets are typically formed from an elastomeric material by molding, or alternatively, may be formed by extrusion, in which a length of extruded material is cut and the ends of the material are secured to one another in a suitable manner to form an annular shaped gasket. The gasket is mounted within an opening in a structure, typically by embedding a portion of the gasket in the structure when the structure is cast, or by using an expansion band to radially compress the gasket into engagement with the interior wall of an opening in the structure. When a pipe is inserted through the gasket opening, the outer surface of the pipe engages the gasket to provide a fluid tight seal between the pipe and the structure.

Specifically, some known gaskets are provided with an inwardly extending sealing portion, which resiliently engages the outer surface of the pipe in a wiping manner to form a fluid tight seal. A disadvantage with these types of gaskets is that irregularities in the gasket or in the pipe surface could result in an ineffective seal between the gasket and the pipe. Alternatively, separate clamping bands may be needed to clamp the gasket to the outer surface of the pipe to effect a fluid tight seal therebetween. Although clamping bands are effective, the use of clamping bands requires additional labor and also adds additional assembly steps to the installation of a pipe connection to a structure.

A structure such as a manhole riser or a septic tank may be provided with several openings, each fitted with a gasket. In many applications however, it is not known which openings and gaskets will be used for pipe joints until the structure is actually installed in the field. Any unused openings are usually closed by a separate cap which is fixed to the unused gasket of the opening to close same in a fluid tight manner. The caps must be able to withstand any internal pressures from within the structure, as well as external pressures from outside the structure. Problematically, closing unused openings of the structure with caps requires additional labor during the installation of the structure.

Another problem with known gaskets is that many known gaskets are specifically dimensioned to receive and provide a seal with only pipes of a single, specific size. For example, use of many known gaskets is restricted to pipes of a single, specific outer diameter. Problematically, however, if a structure is cast which includes one or more gaskets embedded in the structure, it is often not known what specific size of pipes will be used to connect to the structure in the field. If pipes of the particular needed size are not on hand when the structure is installed in the field, obtaining pipes of the needed size could lead to installation delays.

What is needed is a gasket for providing a fluid tight connection between a pipe and a structure, which is an improvement over the foregoing.

### SUMMARY OF THE INVENTION

The present invention provides a pipe joint gasket with a closed end face. An annular anchoring projection extends outwardly from the external surface of the gasket and is embedded within a structure with which the gasket is used. The gasket also includes a sealing projection for engaging a pipe to provide a compressive, fluid tight seal between the pipe and the gasket. In applications in which the gasket is used for a pipe joint, the closed end face of the gasket may be slit or removed to allow a pipe to pass through the gasket. Alternatively, in applications in which the gasket is not used for a pipe joint, the end face remains intact, and has a thickness sufficient to withstand internal pressures within the structure and external pressures from without the structure. In an alternate embodiment, the gasket is configured for use with at least two different sizes of pipe.

The gasket has a sealing projection integrally formed with the body portion of the gasket. The sealing projection is foldable about a hinge portion of the gasket between first and second stable positions. The sealing projection is disposed in its first stable position when the gasket is installed within the structure, wherein a material such as concrete is poured around forms and around the gasket and, when the concrete cures, the anchoring projection is embedded within the concrete to secure the gasket within an opening in the structure. The sealing projection is then separated from the material, if necessary, and folded inwardly to its second stable position. The end face of the gasket is slit or removed to allow a pipe to pass through the gasket. Thereafter, when the pipe is inserted through the gasket, the sealing projection is compressed between the pipe and the body of the gasket to form a fluid tight seal with the outer surface of the pipe.

Advantageously, in applications in which the gasket is not used for a pipe joint, the closed end face of the gasket remains intact, such that the need for a separate end cap for closing the gasket is eliminated. When the gasket is used for a pipe joint, the end face of the gasket may be easily slit or cut away from the remainder of the gasket to create and opening through which a pipe may pass through the gasket. A further advantage is that, because a fluid tight seal is formed by compression of the sealing projection of the gasket between the pipe and the body of the gasket, separate clamping bands are not required to provide a seal between the pipe and the gasket.

In an alternate embodiment, the gasket includes an auxiliary sealing portion adjacent the closed end face, and can provide a seal with pipes of at least two different outer diameters. The sealing portion may be configured as an inwardly radially projecting portion of the body of the gasket. For providing a seal with a pipe having a relatively larger outer diameter, the gasket is cast in place within the structure, and the closed end face is slit or removed. Thereafter, without folding the sealing projection from the first position to the second position, the pipe is inserted through the gasket, and the sealing portion is compressed between the outer surface of the pipe and the concrete structure to provide a fluid tight seal between the pipe and the structure. If a pipe having a relatively smaller outer diameter is used, the sealing projection is folded inwardly from its first stable position to its second stable position. After the end face is slit or removed, the pipe is inserted through the gasket and the sealing projection is compressed between the pipe and the body of the gasket to form a fluid tight seal with the outer surface of the pipe. Advantageously, the gasket of this embodiment can accommodate two different sizes of pipe, thereby increasing the versatility of the gasket in field installations.

In one form thereof, the present invention provides a gasket, including an annular body having a first end, an opposite second end, an exterior surface, and an interior surface; a wall portion extending across and closing the first end of the body; an annular sealing projection connected to the second end of the body, the sealing projection movable between a first position in which the sealing projection extends outwardly from the body and a second position in which the sealing projection is disposed within the body and is compressible against the body.

In another form thereof, the present invention provides a gasket for providing a seal between a pipe and a circular opening in a structure, the gasket including an annular body having a first end, an opposite second end, an exterior surface, and an interior surface; means extending across the first end of the body for alternatively closing the first end of the body or providing an opening through the first end of the body; an annular sealing projection connected to the second end of the body, the sealing projection movable between a first position in which the sealing projection extends outwardly of the body and a second position in which the sealing projection is disposed within the body and adjacent the interior surface of the body; whereby the sealing projection in the second position is compressible against the annular body upon insertion of a pipe through the opening.

In another form thereof, the present invention provides, in combination, a structure having a wall with a circular opening therein; and a gasket installed within the opening,the gasket including an annular body having a first end, an opposite second end, an exterior surface, and an interior surface; a wall portion closing the first end of the annular body, the wall portion selectively penetrable to provide a pipe opening therethough; an annular sealing projection connected to the second end of the body, the sealing projection movable between a first position in which the sealing projection extends outwardly from the body and a second position in which the sealing projection is disposed within the body; whereby the sealing projection is compressible against the body in the second position upon insertion of a pipe through the pipe opening.

In a further form thereof, the present invention provides a gasket, including an annular body having a first end, an opposite second end, an exterior surface, and an interior surface; a sealing portion projecting radially inwardly from the body; an annular sealing projection connected to the second end of the body, the sealing projection movable between a first position in which the sealing projection extends axially outwardly from the body and a second position in which the sealing projection is disposed within the body and is compressible against the body; whereby when the sealing projection is in the first position, the sealing portion projects radially inwardly further than the sealing projection, and when the sealing projection is in the second position, the sealing projection projects radially inwardly further than the sealing portion.

In a further form thereof, the present invention provides a method of providing a seal between a pipe and a structure, including the steps of installing a body of a gasket within an opening in the structure; cutting a closed face of the gasket to form an opening through the gasket; folding a sealing projection of the gasket from a first position in which the sealing projection extends substantially longitudinally away from the body of the gasket to a second position in which the sealing projection is disposed within the body of the gasket; and inserting a pipe through the opening to compress the sealing projection between the pipe and the body of the gasket.

In a further form thereof, the present invention provides a method of providing a seal between a pipe and a structure, comprising the steps of: installing a body of a gasket within an opening in the structure; cutting a closed face of the gasket to form an opening through the gasket; and inserting a pipe through the opening to engage a sealing portion of the gasket which extends radially inwardly of the body of the gasket and to compress the sealing portion between the pipe and the body of the gasket.

### BRIEF DESCRIPTION OF THE DRAWINGS

The above-mentioned and other features and objects of this invention will become more apparent and the invention itself will be better understood by reference to the following description of an embodiment of the invention taken in conjunction with the accompanying drawings, wherein:

FIG. 1 is a partially sectioned perspective view of a pipe joint, including a pipe sealingly mounted in a concrete structure using a pipe joint gasket in accordance with a first embodiment of the present invention;

FIG. 2 is a sectional view of the gasket of FIG. 1;

FIG. 3 is sectional view showing the manner in which the gasket is mounted within the structure, using forms positioned to confine the gasket and the concrete when casting the structure;

FIG. 4 is a perspective view of the gasket of the first embodiment mounted within the structure, showing a portion of the sealing projection of the gasket being folded inwardly from its first stable position to its second stable position;

FIG. 5 is a perspective view of the gasket of the first embodiment mounted within the structure with the sealing projection of the gasket folded inwardly to its second stable position, and further showing a pipe being inserted through the gasket;

FIG. 6 is a sectional view of a portion of the gasket of the first embodiment, showing the first stable position of the sealing projection in solid lines, and the second stable position of the sealing projection in dashed lines.

FIG. 7 is a sectional view of a gasket according to a second embodiment of the present invention;

FIG. 8 is a partially sectioned perspective view showing the gasket of FIG. 7 mounted within a structure, with the sealing projection of the gasket folded inwardly to its second stable position and the end face of the gasket removed, and further showing a pipe having a relatively smaller diameter being inserted through the gasket;

FIG. 9 is a partially sectioned perspective view showing the gasket of FIGS. 7 and 8 mounted within a structure, and showing the pipe sealingly connected to the structure by the gasket;

FIG. 10 is a partially sectioned perspective view showing the gasket of FIG. 7 mounted within a structure, with the sealing projection of the gasket in its first stable position and the end face of the gasket removed, and further showing a pipe having a relatively larger diameter being inserted through the gasket; and

FIG. 11 is a partially sectioned perspective view showing the gasket of FIGS. 7 and 10 mounted within the structure, and showing the pipe sealingly connected to the structure by the gasket.

Corresponding reference characters indicate corresponding parts throughout the several views. Although the drawings represent embodiments of the present invention, the drawings are not necessarily to scale and certain features may be exaggerated in order to better illustrate and explain the present invention. The exemplifications set out herein illustrate preferred embodiments of the invention and such exemplifications are not to be construed as limiting the scope of the invention in any manner.

### DETAILED DESCRIPTION

Referring to FIG. 1, a pipe joint application is shown, including a concrete structure 10, such as a manhole riser, in which at least a portion of a gasket or seal 12 is embedded. Pipe 14 extends through gasket 12, and gasket 12 provides a fluid tight seal between pipe 14 and structure 10. Except as discussed below, the overall structure and function of gasket 12 is similar to the gasket which is described in U.S. Pat. No. 4,809,994, assigned to the assignee of the present invention, the disclosure of which is expressly incorporated herein by reference.

Although the pipe joint application shown in FIG. 1 and described below is between a pipe and a concrete structure such as a manhole riser, the present gasket may generally be used in any application in which a pipe is mounted to an opening within a structure. For example, the present gasket may also be used in a septic tank having a plurality of inlets to which one or more pipes are respectively connected. Also, although structure 10 is illustrated and described below as being formed from concrete, structure 10 may alternatively be formed from other suitable materials, such as iron, steel, or plastic, for example.

Concrete structure 10 is provided with opening 16 extending therethrough, in which gasket 12 and pipe 14 are received. Opening 16, and thus gasket 12 and pipe 14, may have any suitable diameter, depending on the particular application. Gasket 12 provides a fluid tight seal or joint between opening 16 and exterior surface 18 of pipe 14 and, as described below, gasket 12 is constructed such that the fluid tight joint between structure 10 and pipe 14 is maintained even if the diameter of pipe 14 varies slightly from the diameter of gasket 12, or if pipe 14 is angled as it extends through opening 16.

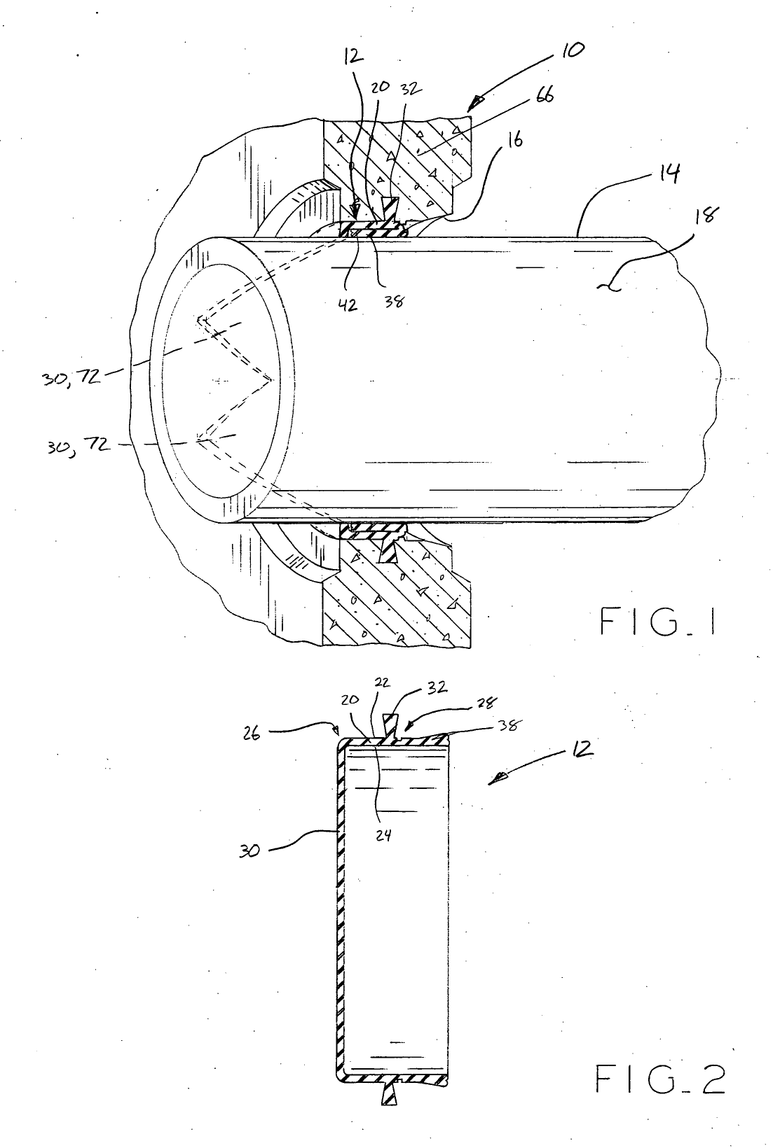

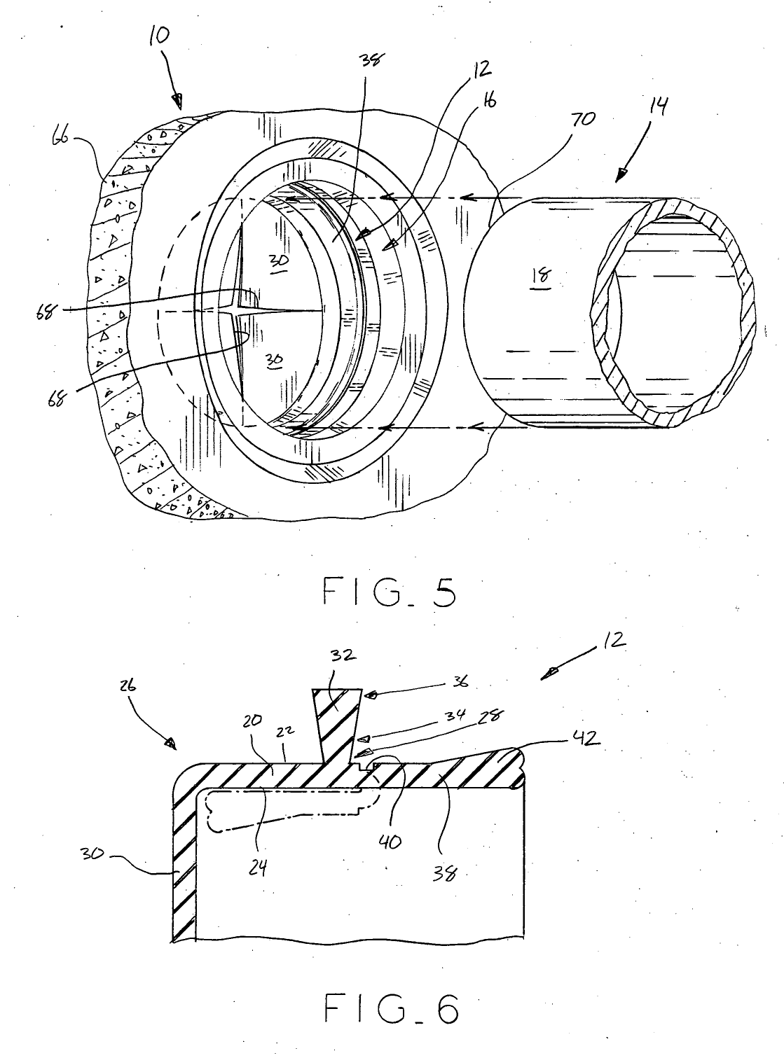

Referring to FIGS. 2 and 6, gasket or seal 12 includes an annular main body portion 20 having exterior surface 22 and interior surface 24. Body portion 20 also includes a first end 26 and a second end 28. First end 26 defines a closed end face, specifically, first end 26 is closed by a wall 30 which extends across first end 26 of body portion 20. Second end 28 defines an annular open end face of gasket 12.

Extending substantially perpendicularly from exterior surface 22 of body portion 20 of gasket 12 is anchoring projection 32. Anchoring projection 32 extends radially outwardly around the circumference of gasket 12 and, as best shown in FIG. 6, includes neck portion 34 and end portion 36. Anchoring projection 32 has a tapered profile, wherein the thickness of anchoring projection 32 at neck portion 34 is less than that at end portion 36 to provide a locking engagement with structure 10, as described further below.

Sealing projection 38 is attached to main body portion 20 of gasket by hinge 40, and is movable between a first stable position shown in solid lines in FIG. 6 and a second stable position shown in dashed lines in FIG. 6. Sealing projection 38 has a tapered profile in section, including enlarged end 42 distal of body 20 of gasket 12, which increases in thickness in an outward direction from hinge 40. Hinge 40 is formed as an annular notch, providing a hinge point about which sealing projection 38 may be manually folded. Specifically, in the first stable position, sealing projection 38 extends longitudinally outwardly from second end 28 of body portion 20 of gasket 12. In this first position, shown in solid lines in FIG. 6, sealing projection 38 is stable, such that sealing projection 38 will remain in such position in the absence of external forces applied thereto. Sealing projection 38 is foldable about hinge 40 to its second stable position, shown in dashed lines in FIG. 6, in which sealing projection 38 is disposed inwardly of body portion 20 of gasket 12 and adjacent interior surface 24 of body portion 20. Sealing projection 38 is also stable in its second position, such that sealing projection 38 will remain in such position in the absence of external forces applied thereto.

Gasket 12 may be formed from a suitable elastomeric material such as isoprene or EPDM rubber, for example, which is flexible and compressible. Gasket 12 may be formed by compression molding, wherein body portion 20, wall 30, anchoring projection 32, and sealing projection 38 are integrally formed in a single-step molding process. However, gasket 12 may also be formed by other suitable methods, and the foregoing portions of gasket 12 need not be integrally formed with one another. For example, body portion 20, anchoring projection 32, and sealing projection 38 of gasket 12 may be integrally formed by an extrusion process, wherein a length of extrusion is cut and the ends thereof joined by vulcanization or adhesive, for example, to form the annular portion of gasket 12. Then, wall 30 may be joined to body portion 20 of gasket 12 by a separate process. Other methods by which gasket 12 may be formed will be apparent to those skilled in the art.

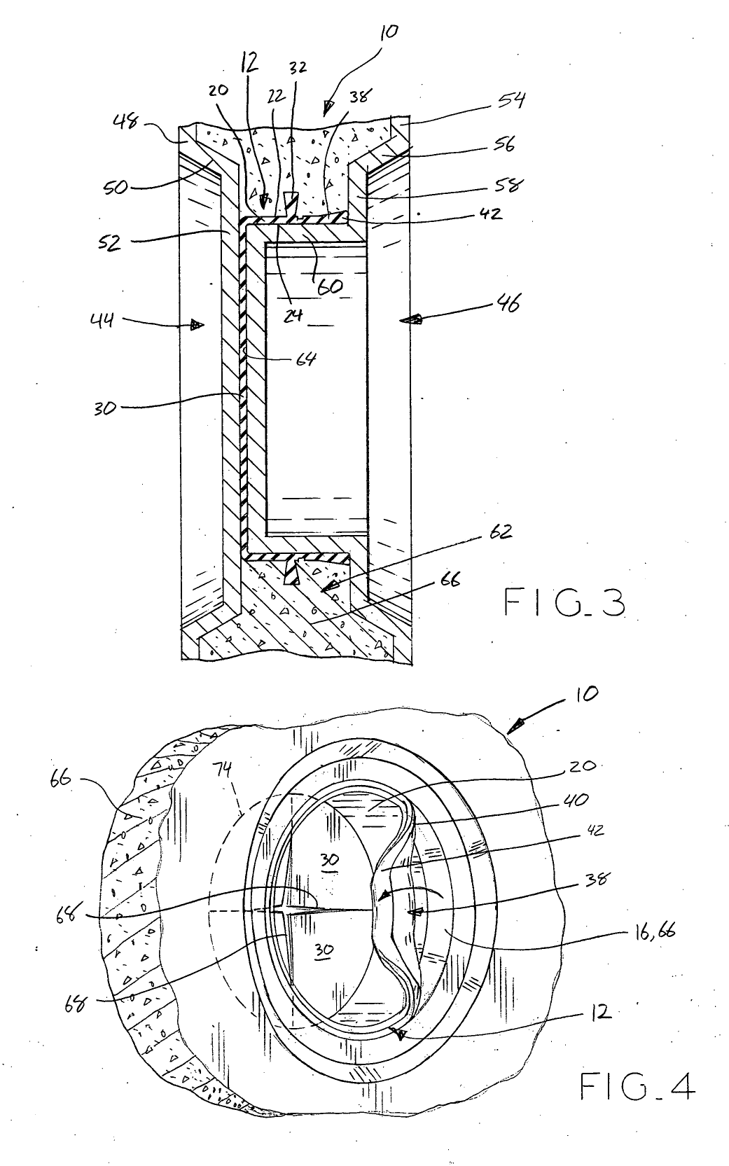

Referring to FIG. 3, gasket 12 is mounted within concrete structure 10 using a pair of forms 44 and 46, which isolate exterior surface 22 of body portion 20, anchoring projection 32, and the external surface of sealing projection 38 of gasket 12, and prevent concrete from contacting the internal surfaces and wall 30 of gasket 12. Form 44 includes main wall portion 48 having transition portion 50 and inner wall portion 52. Inner wall portion 52 is in abutting contact with the outer surface of wall 30 of gasket 12 when assembled. Form 46 includes main wall portion 54 and transition portion 56 between wall portion 54 and inner wall portion 58. Extending inwardly from inner wall portion 58 is core 60, which is substantially cup-shaped and engages the interior surface 24 of body portion 20 of gasket 12, the interior surface of wall 30, and the interior surface of sealing projection 38. The portions of forms 44 and 46 which are not in contact with gasket 12 define an area 62 for receiving concrete 66 to form structure 10.

In assembly of forms 44 and 46 with gasket 12, gasket 12 is placed over core 60 of form 46 until wall 30 of gasket 12 is in abutting contact with surface 64 of core 60 and enlarged end 42 of sealing projection 38 of gasket 12 is in contact with inner wall portion 58 of form 46. The engagement between enlarged end 42 and inner wall portion 58 prevents material from lodging therebetween or flowing into any space between core 60 and the inner surface of sealing projection 38. Assembly of gasket 12 onto core 60 is relatively easy with sealing projection 38 in its first stable position. Form 44 is then positioned with inner wall portion 50 thereof in abutting contact with the outer surface of wall 30.

After gasket 12 is assembled with forms 44 and 46, concrete 66 or another suitable material is poured into area 62, filling area 62 around the outer surface of gasket 12. Concrete 66 surrounds anchoring projection 32 of gasket 12 to permanently embed anchoring projection 32 within concrete 66 and lock gasket 12 in position within opening 16 formed in concrete structure 10. Specifically, the portion of concrete 66 around the tapered neck portion 34 (FIG. 6) of anchoring projection 32 acts to lock gasket 12 in place, preventing removal of gasket 12 from concrete structure 10, as end portion 36 (FIG. 6) of anchoring projection 32 is too thick to pass through the opening defined by the concrete around neck portion 34 of anchoring projection 32. Forms 44 and 46 are removed after concrete 66 sets up and hardens, with gasket 12 remaining in position in concrete structure 10. Sealing projection 38 remains in its first stable position until a user manually folds same inwardly to its second stable position, and described below. In this manner, sealing projection 38 is protected from damage during shipping or handling or the concrete structure 10.

When a user is ready to install pipe 14 to concrete structure 10, sealing projection 38 is pried away from concrete structure 10 and manually folded inwardly to its second stable position, as shown in FIG. 4. As there is no interlocking connection between enlarged end 42 of sealing projection 38 and concrete 66, the user may pull sealing projection 38 away from concrete 66. If necessary, a tool such as a screwdriver, for example, may be inserted between enlarged end 42 of sealing projection 38 and concrete 66 to facilitate in disengaging sealing projection 38 from concrete 66. As shown in FIG. 4, sealing projection 38 is then grasped and manually folded about hinge 40 from its first stable position to its second stable position.

In an alternate installation method, gasket 12 may be cast within structure 10 with sealing projection 38 of gasket 12 folded to its second stable position. In this method, sealing projection 38 is first folded to its second stable position, and a mandrel (not shown) is fitted within body 20 and sealing projection 38 of gasket 12 in place of form 46. Thereafter, structure is cast as described above.

Either before or after sealing projection 38 is folded from its first stable position to its second stable position, wall 30 is penetrated to create a pipe opening therethrough. Specifically, as shown in FIG. 4, wall 30 may be cut by making one or more slits at 68 with a suitable sharp tool to create a pipe opening through wall 30, such that pipe 14 may extend therethrough. Alternatively, wall 30 may be cut about the entire perimeter or circumference thereof along line 74, as shown in FIGS. 4, 8, and 10, and then removed from the remainder of gasket 12 and discarded.

Notably, if there is no need to connect pipe 14 to the particular opening 16 in concrete structure 10 in which a gasket 12 is installed, the wall 30 of that gasket 12 is left intact. Advantageously therefore, in applications in which gasket 12 is not being used for a pipe joint, wall 30 of gasket 12 eliminates the need for a separate end cap to be attached to gasket 12 for closing opening 16, as in known gaskets. The thickness of wall 30 is sufficient to withstand internal pressures within structure 10, as well as external pressures from without structure 10, such as from surrounding soil and/or water. For example, wall may have a thickness of between about 0.06 inches and about 0.1 inches or more, depending upon the particular application in which gasket 12 is used. The thickness of wall 30 may be selected as desired for the particular application in which gasket 12 is used to provide suitable pressure resistance while also facilitating easy cutting or removal of wall 30. As discussed above, when gasket 12 is used for a pipe joint, wall 30 may be simply slit or cut away from the remainder of gasket 12 to create a pipe opening to allow pipe 14 to pass through gasket 12.

As shown in FIGS. 1 and 5, after sealing projection 38 of gasket 12 is folded to its second stable position, end 70 of pipe 14 is forced through gasket 12. Contact between outer surface 18 of pipe 14 and sealing projection 38 radially compresses sealing projection 38 of gasket 12 against body portion of gasket 12, as shown in FIG. 1. In turn, body portion 20 of gasket 12 is compressed between sealing projection 38 and the wall of opening 16 of structure 10. Enlarged end 42 of sealing projection 38 is compressed to a greater extent than the remainder of sealing projection 38 as pipe 14 is inserted through gasket 12 due to the increased thickness of enlarged end 42, thereby creating a fluid tight, compressive seal between gasket 12 and pipe 14. When pipe 14 is inserted through gasket 12, triangular shaped portions 72 of wall 30, which are formed by slits 68 in wall 30, extend outwardly from gasket 12 and are in abutting contact with the exterior surface 18 of pipe 14.

The diameter of pipe 14 may vary slightly with the pipe diameter not being exactly equal to the nominal inner diameter of gasket 12. For example, if the diameter of pipe 14 is slightly less than the nominal inner diameter of gasket 12, the above-described radial compression of sealing projection 38 of gasket 12 may be somewhat lessened while still providing a fluid tight joint between gasket 12 and pipe 14. Alternatively, if the diameter of pipe 14 is slightly greater than the nominal inner diameter of gasket 12, above-described radial compression of sealing projection 38 of gasket 12 is increased to provide a more robust fluid tight joint between gasket 12 and pipe 14. Further, the fluid tight seal which is formed by compression of sealing projection 38 of gasket 12 by direct contact between pipe 14 and body 20 of gasket 12 eliminates the need for separate clamping bands, which are necessary to provide a seal between pipe 14 and many known gaskets.

As an alternative to the above, gasket 12 may lack anchoring projection 32, wherein such gasket is installed within a pre-formed opening in a structure using an expansion band assembly, for example, to compress the body of the gasket into sealing engagement with the wall of the opening.

Further, the first and second positions of sealing projection 38 of gasket 12, shown in solid and in dashed lines in FIG. 6, respectively, need not necessarily be stable. For example, after sealing projection 38 of gasket 12 is folded inwardly to its second position, sealing projection 38 could be manually or otherwise held in that position until pipe 14 is inserted through gasket 12 to compress sealing projection 38 between pipe 14 and body 20 of gasket.

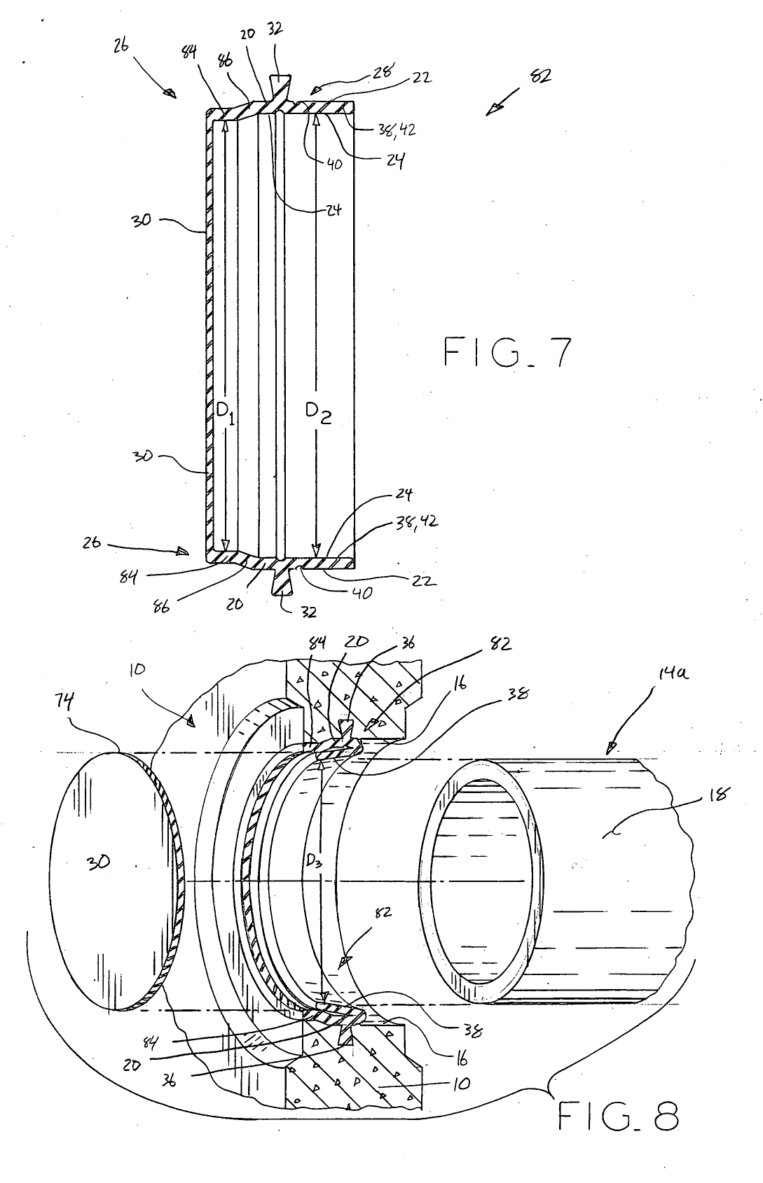

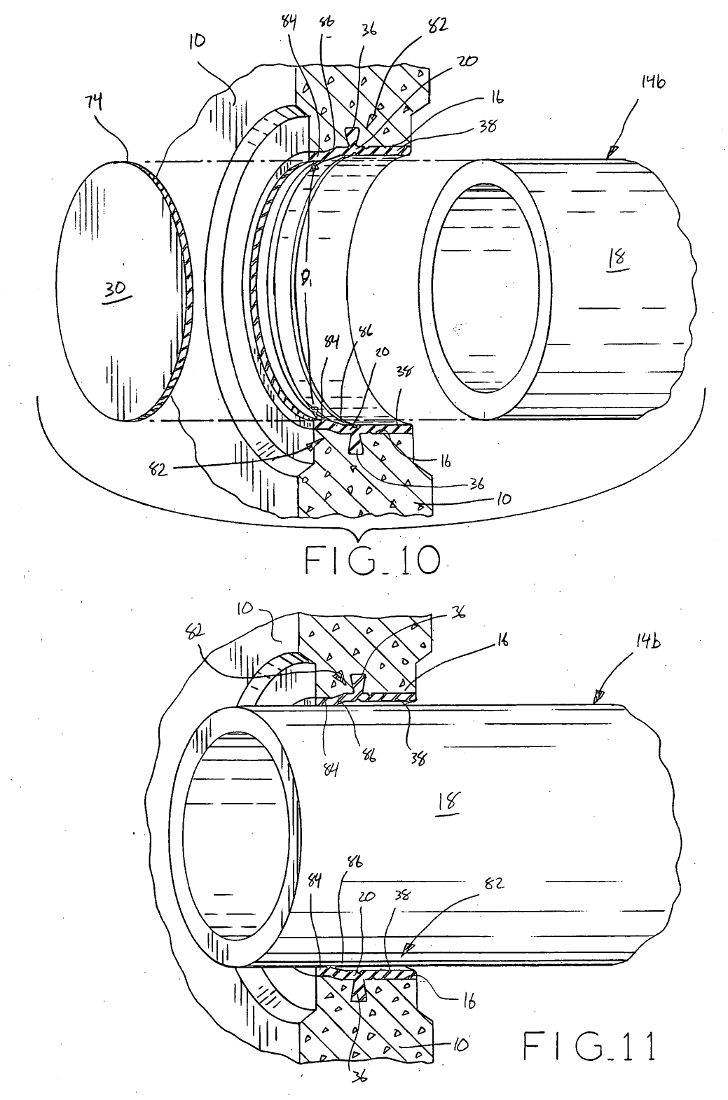

Referring to FIGS. 7-11, gasket 82 according to a second embodiment of the present invention is described. Except as described below, gasket 82 is identical to gasket 12 which is shown in FIGS. 1-6 and described above, and identical reference numerals are used to identify common features between gaskets 12 and 82. Referring to FIG. 7, first end 26 of gasket 82 includes an auxiliary sealing portion 84 adjacent wall 30, which is connected to body 20 of gasket 82 by a transition portion 86. As shown in FIG. 7, transition portion 86 defines an inwardly radially projecting bend in body 20 of gasket 82, such that sealing portion 84 projects radially inwardly of body 20 of gasket 82. Specifically, sealing portion 84 of gasket 82 has a first diameter D₁ which is less than a second diameter D₂ of the remainder of body 20 and sealing projection 38 of gasket 82 when sealing projection 38 in its first stable position, as shown in FIG. 7.

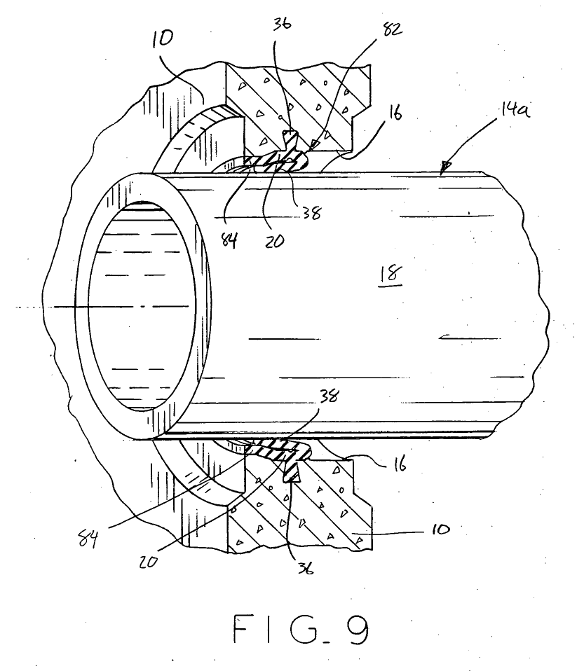

Referring to FIGS. 8 and 9, gasket 82 is embedded within concrete structure 10 in the same manner as described above with respect to gasket 12. After gasket 82 is embedded within concrete structure 10, sealing projection 38 may be folded from its first stable position, shown in FIG. 7, to its second stable position, shown in FIG. 8. As shown in FIG. 8, when sealing projection 38 is folded to its second stable position, sealing projection 38 projects radially interiorly from body 20 of gasket 82 further than sealing portion 84. Thus, as described below, sealing projection 38 provides a fluid tight seal with pipe 14a of a relatively smaller diameter, as opposed to sealing portion 84. Wall 30 may be removed from the remainder of gasket 82 by cutting with a suitable tool around the perimeter 74 of wall 30, or alternatively, wall 30 may be slit as shown in FIGS. 4 and 5.

Thereafter, as shown in FIG. 8, a pipe 14a of a relatively smaller diameter may be inserted within gasket 82. One exemplary pipe 14a has an outer diameter of about 4.21±0.01 inches, which is a size of pipe currently commonly available from many commercial sources. For use with this size of pipe, the diameter D₂ (FIG. 7) of gasket 82 at sealing projection 38, when sealing projection is in its first stable position, is typically about 4.520 inches. However, gasket 82 may also be dimensioned for use with other known pipe sizes, such as pipes having outer diameters of about 6, 8, 10, and 12 inches, for example. Once sealing projection 38 of gasket 82 is folded to its second stable position, the inner diameter of sealing projection 38, diameter D₃ in FIG. 8, is about 4.12 inches, and is less than the outer diameter of pipe 14a. Upon insertion of pipe 14a into gasket 82 as shown in FIG. 9, sealing projection 38 is radially compressed between outer surface 18 of pipe 14a and body 20 of gasket 82 to provide a compressive, fluid tight seal between gasket 82 and pipe 14a.

As described below, gasket 82 may advantageously be used to provide a fluid tight seal not only with pipe 14a of a relatively smaller outer diameter, but also with a second pipe 14b having an outer diameter which is larger than that of pipe 14a. Referring to FIG. 10, gasket 82 is embedded within concrete structure 10 in the same manner as described above with respect to gasket 12. Thereafter, wall 30 of gasket 82 is removed from the remainder of gasket 82 by cutting with a suitable tool around the perimeter 74 of wall 30. Alternatively, wall 30 may be slit as shown in FIGS. 4 and 5. In applications in which gasket is used with pipe 14b, sealing projection 38 is maintained in its first stable position, and is not folded to its second stable position. As shown in FIG. 10, in this position, sealing portion 82 of gasket 82 projects radially inwardly from body 20 of gasket 82 further than does sealing projection 38, such that sealing portion 84 provides a seal with pipe 14b, as opposed to sealing projection 38.

Thereafter, pipe 14b is inserted through gasket 82 while maintaining sealing projection 38 of gasket 82 in its first stable position. One exemplary pipe 14b has an outer diameter of about 4.5±0.01 inches, which is a size of pipe currently commonly available from many commercial sources. For use with this size of pipe, the diameter D₁ (FIG. 7) of gasket 82 is typically about 4.392 inches. However, gasket 82 may also be dimensioned for use with other known pipe sizes, such as pipes having outer diameters of about 6, 8, 10, and 12 inches, for example. Upon insertion of pipe 14b into gasket 82 as shown in FIG. 10, outer surface 18 of pipe 14b engages sealing portion 84 of gasket 82, thereby radially compressing sealing portion 82 between outer surface 18 of pipe 14b and concrete structure 10 to provide a compressive, fluid tight seal between pipe 14b and structure 10.

Advantageously, gasket 82 may therefore be used both with pipe 14a having a relatively smaller outer diameter, and with pipe 14b having a relatively larger outer diameter than pipe 14a. In this manner, gasket 82 may be selectively used with two different sizes of pipes, and is therefore especially useful in applications in which, at the time gasket 82 is installed within structure 10, it is not yet known which size of pipe 14a or 14b will be used to connect to structure 10. As described above, gasket 82 may be selectively configured in the field to provide a fluid tight seal between structure 10 and either pipe 14a having a relatively smaller outer diameter, or pipe 14b having a relative larger outer diameter.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A gasket, comprising:
an annular body having a first end, an opposite second end, an exterior surface, and an interior surface;
a wall portion extending across and closing said first end of said body;
an annular sealing projection connected to said second end of said body, said sealing projection movable between a first position in which said sealing projection extends outwardly from said body and a second position in which said sealing projection is disposed within said body and is compressible against said body.

2. The gasket of claim 1, wherein said sealing projection is stable in at least one of said first and said second positions, whereby said sealing projection remains in its position in the absence of external forces applied thereto.

3. The gasket of claim 1, further comprising an anchoring projection extending radially from said exterior surface of said body.

4. The gasket of claim 1, wherein said sealing projection extends substantially longitudinally from said body in said first position.

5. The gasket of claim 1, whereby a pipe may be inserted through said wall portion upon making one or more slits in said wall portion.

6. The gasket of claim 1, whereby a pipe may be inserted through said body upon removing said wall portion from said body.

7. The gasket of claim 1, wherein said gasket is made of an elastomeric material, with said body, said wall portion, and said sealing projection integrally formed with one another.

8. The gasket of claim 1, further comprising an annular hinge portion connecting said body and said sealing projection, said sealing projection foldable about said hinge portion between said first and second positions.

9. The gasket of claim 1, wherein said sealing projection includes an enlarged end portion distal from said body.

10. The gasket of claim 1, wherein said body includes an auxiliary sealing portion having a diameter less than a diameter of the remainder of said body, said sealing portion projecting radially inwardly from said body further than said sealing projection in said first sealing projection position, and said sealing projection projecting radially inwardly from said body further than said sealing portion in said second sealing projection position.

11. A gasket for providing a seal between a pipe and a circular opening in a structure, said gasket comprising:
an annular body having a first end, an opposite second end, an exterior surface, and an interior surface;
means extending across said first end of said body for alternatively closing said first end of said body or providing an opening through said first end of said body;
an annular sealing projection connected to said second end of said body, said sealing projection movable between a first position in which said sealing projection extends outwardly of said body and a second position in which said sealing projection is disposed within said body and adjacent said interior surface of said body;
whereby said sealing projection in said second position is compressible against said annular body upon insertion of a pipe through said opening.

12. The gasket of claim 11, wherein said sealing projection is stable in at least one of said first and said second positions, whereby said sealing projection remains in its position in the absence of external forces applied thereto.

13. The gasket of claim 11, further comprising an anchoring projection extending radially from said exterior surface of said body.

14. The gasket of claim 11, wherein said gasket is made of an elastomeric material with said body and said sealing projection integrally formed with one another.

15. The gasket of claim 11, wherein said sealing projection increases in thickness from said body to an end portion of said sealing projection.

16. The gasket of claim 11, further comprising auxiliary sealing means projecting radially inwardly from said body further than said sealing projection when said sealing projection is in said first sealing projection position.

17. In combination:
a structure having a wall with a circular opening therein; and
a gasket installed within said opening, said gasket comprising:
an annular body having a first end, an opposite second end, an exterior surface, and an interior surface;
a wall portion closing said first end of said annular body, said wall portion selectively penetrable to provide a pipe opening therethough;
an annular sealing projection connected to said second end of said body, said sealing projection movable between a first position in which said sealing projection extends outwardly from said body and a second position in which said sealing projection is disposed within said body;
whereby said sealing projection is compressible against said body in said second position upon insertion of a pipe through said pipe opening.

18. The combination of claim 17, wherein said sealing projection is stable in at least one of said first and said second positions, whereby said sealing projection remains in its position in the absence of external forces applied thereto.

19. The combination of claim 17, wherein said gasket further comprises an anchoring projection extending radially from said exterior surface of said body, said anchoring projection embedded within said wall.

20. The combination of claim 19, wherein said gasket is made of an elastomeric material with said body, said sealing projection, and said anchoring projection integrally formed with one another.

21. The combination of claim 17, whereby said pipe opening is formed by making one or more slits in said wall portion.

22. The combination of claim 17, whereby said pipe opening is formed by removing said wall portion from said body.

23. The gasket of claim 17, further comprising an auxiliary sealing portion projecting radially inwardly from said body further than said sealing projection when said sealing projection is in said first sealing projection position, said auxiliary sealing portion engageable with a pipe upon insertion of a pipe through said pipe opening.

24. A gasket, comprising:
an annular body having a first end, an opposite second end, an exterior surface, and an interior surface;
a sealing portion projecting radially inwardly from said body;
an annular sealing projection connected to said second end of said body, said sealing projection movable between a first position in which said sealing projection extends axially outwardly from said body and a second position in which said sealing projection is disposed within said body and is compressible against said body;
whereby when said sealing projection is in said first position, said sealing portion projects radially inwardly further than said sealing projection, and when said sealing projection is in said second position, said sealing projection projects radially inwardly further than said sealing portion.

25. The gasket of claim 24, further comprising a wall portion extending across and closing said first end of said annular body.

26. The gasket of claim 24, wherein said sealing projection is stable in at least one of said first and said second positions, whereby said sealing projection remains in its position in the absence of external forces applied thereto.

27. The gasket of claim 24, further comprising an anchoring projection extending radially from said exterior surface of said body.

28. A method of providing a seal between a pipe and a structure, comprising the steps of:
installing a body of a gasket within an opening in the structure;
cutting a closed face of the gasket to form an opening through the gasket;
folding a sealing projection of the gasket from a first position in which the sealing projection extends substantially longitudinally away from the body of the gasket to a second position in which the sealing projection is disposed within the body of the gasket; and
inserting a pipe through the opening to compress the sealing projection between the pipe and the body of the gasket.

29. The method of claim 28, wherein said cutting step comprises making at least one cut substantially across the closed face of the gasket.

30. The method of claim 28, wherein said cutting step further comprises removing the closed face of the gasket from the body of the gasket.

31. The method of claim 28, wherein said folding step is carried out prior to said cutting step.

32. A method of providing a seal between a pipe and a structure, comprising the steps of:
installing a body of a gasket within an opening in the structure;
cutting a closed face of the gasket to form an opening through the gasket; and
inserting a pipe through the opening to engage a sealing portion of the gasket which extends radially inwardly of the body of the gasket and to compress the sealing portion between the pipe and the body of the gasket.

33. The method of claim 32, wherein said cutting step comprises making at least one cut substantially across the closed face of the gasket.

34. The method of claim 32, wherein said cutting step further comprises removing the closed face of the gasket from the body of the gasket.
